(19) United States
(12) Patent Application Publication
(10) Pub. No.: US 2019/0063660 A1
(43) Pub. Date: Feb. 28, 2019

(54) INFLATABLE SEALANT APPARATUS FOR DRAIN PIPES

(71) Applicant: RAYMOND ARMSTRONG VALDEZ, INDIO, CA (US)

(72) Inventor: RAYMOND ARMSTRONG VALDEZ, INDIO, CA (US)

(21) Appl. No.: 16/116,571

(22) Filed: Aug. 29, 2018

Related U.S. Application Data
(60) Provisional application No. 62/551,795, filed on Aug. 30, 2017.

(51) Int. Cl. F16L 55/134; F24F 13/22

(52) U.S. Cl. CPC F16L 55/134; F24F 13/222

(57) ABSTRACT

An apparatus that forms a temporary seal to keep the sections of a drain pipe that are not clogged isolated from the regions that are clogged, is described. The temporary seal prevents high pressure applied in the drain pipe to dissipate over the unclogged sections, to maintain the pressure required to remove the clog. The apparatus includes a bladder attached to one end of a conduit. A dual valve connector is attached to the other end of the conduit. The dual valve connector allows connection of the apparatus to a source for gaseous pressure for inflation of the bladder and, retains the pressurized gas inside the bladder so that the seal is maintained during the removal of the clog.

### RELATED APPLICATIONS

This patent application claims priority from the U.S. Provisional Patent Application Ser. No. 62/551,795, filed Aug. 30, 2017.

### TECHNICAL FIELD

This patent application relates to techniques of clearing clogs in drain pipes, and more particularly, to an inflatable sealant for clearing clogs in drain pipes of air conditioning (AC) systems.

### BACKGROUND OF THE INVENTION

An air conditioning system includes a reservoir for storing condensate which is generated during operation of the air conditioning unit. The reservoir is connected to a drain pipe that discharges the condensate. Generally, the drain pipe has a vent through which it can be accessed. At any point of time during operation of the air conditioning unit, residual condensate may attract the growth of algae and fungi leading to clogging of the drain pipe. Such clogs, if not removed, prevent discharge of condensate from the drain pipe which may lead to accumulation of condensate in the air conditioning unit, thereby obstructing effective operation of the AC unit.

Conventional techniques for removing the clogs use high-pressure nitrogen gas, commonly known as a nitrogen charge. For removal of clogs, the nitrogen charge is pumped into the drain pipe through the vent to forcibly remove the clogs present in the drain pipe. Removal of clog requires high pressure inside the drain pipe since the clog sticks strongly to the inner walls of the drain pipe. However, as the drain pipe is open, the nitrogen under high pressure expands through the drain pipe, which means the pressure at the clog sites becomes often insufficient to remove the clog. In order to achieve the pressure required to remove the clog, the drain pipe is cut and a valve is installed between the clogged portion of the drain pipe and an open portion, to regulate the flow of the nitrogen charge through the clogged portion of the drain pipe. However, such a technique is expensive and complex since it requires skilled labor. In addition, this technique may involve structural modifications to the drain pipe. which may affect the routine operational effectiveness of the drain pipe, for example, by causing a leakage in the drain pipe.

### SUMMARY OF THE INVENTION

Against the foregoing background, it is an object of the disclosure to provide an apparatus for removing clogs in a drain pipe of an AC unit without making structural modifications to the drain pipe. The embodiments presented herein provide a temporary seal of the drain pipe to keep the unclogged and open section of the drain pipe isolated from the clogged section without requiring a cut of the drain pipe, and a valve installation at the cut portion. The temporary seal prevents the nitrogen charge from dispersing through the unclogged/open section, which can otherwise prevent the development of enough pressure at the clog site to remove the clog.

Accordingly, the embodiments described in this specification describe an apparatus for clearing clogs in a drain pipe, comprising: a conduit having a first end and a second end; an inflatable bladder attached to the first end, adapted to assume an inflated state and a deflated state; and a dual valve connector attached to the second end, adapted to removably attach the conduit from a source of pressurized fluid and to monitor the inflated or deflated status of the bladder. The conduit comprises a tubular body with an inner bore; a treaded portion at the second end for attachment to the dual valve connector; and a valve core installed in the inner bore.

The dual valve comprises for example a connector body with a first coupler for attachment to the second end, and a second coupler for attachment to the pressure source; and a valve operator provided in the connector body which actuates the valve core to allow the bladder to inflate, maintain the bladder in the inflated state, and eventually allow the bladder to deflate.

This specification also describes a method of clearing clogs in a drain pipe provided with a vent, comprising: providing a fluid passageway through a sealant apparatus including an inflatable bladder, a dual valve connector and a conduit provided between the bladder and the dual valve connector; installing the sealant apparatus, in a deflated state, in the drain pipe through the vent; actuating the sealant apparatus to assume an inflated state, to separate a clogged section of the drain pipe from another section of the drain pipe; connecting a storage tank with highly pressurized gas to the vent; and pumping the pressurized gas towards the clogged section to clean the clogged section, while the sealant apparatus is maintained in the inflated state.

The method further comprises disconnecting the storage tank from the vent once the clogged section has been cleaned; actuating the sealant apparatus into a deflated state; and removing the sealant apparatus from the drain pipe in the deflated state through the vent. Actuating the sealant apparatus in an inflated state comprises connecting the dual valve connector to a pressured air source; opening the fluid passageway in the dual valve connector and inflating the bladder using the source; closing the fluid passageway in the dual valve connector while maintaining the bladder in an inflated state; and disconnecting the apparatus from the source while maintaining the bladder in the inflated state. Actuating the sealant apparatus into a deflated state comprises: opening a fluid passageway in the dual valve connector to enable the bladder to assume a deflated state once the clogged section of the drain pipe has been cleaned; and deflating the bladder through the open air passageway.

The apparatus described here eliminates the need of making structural modification to the drain pipe, thereby reducing the skill, complexity, and cost associated with de-clogging operation. In addition, the bladder directs the Nitrogen charge towards the clog while keeping other regions of the air conditioning unit isolated and, therefore, allowing development of sufficient pressure inside the drain pipe to remove the clogs.

### BRIEF DESCRIPTION OF DRAWINGS

The drawings accompanying and forming part of this specification are included to depict certain aspects of embodiments of the invention. A clearer impression of embodiments of the invention, and of the components and operation of systems provided with embodiments of the invention, will become more readily apparent by referring to the exemplary, and therefore non-limiting, embodiments illustrated in the drawings, wherein identical reference numerals designate the same components. Note that the features illustrated in the drawings are not necessarily drawn to scale.

FIG. 1 illustrates an embodiment of an apparatus for cleaning clogged drain pipes.

FIG. 2 illustrates an embodiment of a dual valve connector for the apparatus for cleaning clogged drain pipes.

FIG. 3 illustrates a deflated sealant installed inside a drain pipe having a clogged section.

FIG. 4 illustrates an inflated sealant inside drain pipe, separating the clogged section form the rest of the drain pipe.

FIGS. 5 and 6 illustrate the stages of clog removal system, using the embodiments of the apparatus for cleaning clogged drain pipes.

### DETAILED DESCRIPTION

This disclosure describes various features and advantageous details of an apparatus for clearing clogs in drain pipes with reference to the non-limiting embodiments illustrated in the accompanying drawings. Descriptions of well-known starting materials, processing techniques, components and equipment are omitted so as not to unnecessarily obscure the disclosure in detail. Skilled artisans should understand, however, that the detailed description and the specific examples, while disclosing preferred embodiments, are given by way of illustration only and not by way of limitation. Various substitutions, modifications, additions or rearrangements within the scope of the underlying inventive concept(s) will become apparent to those skilled in the art after reading this disclosure.

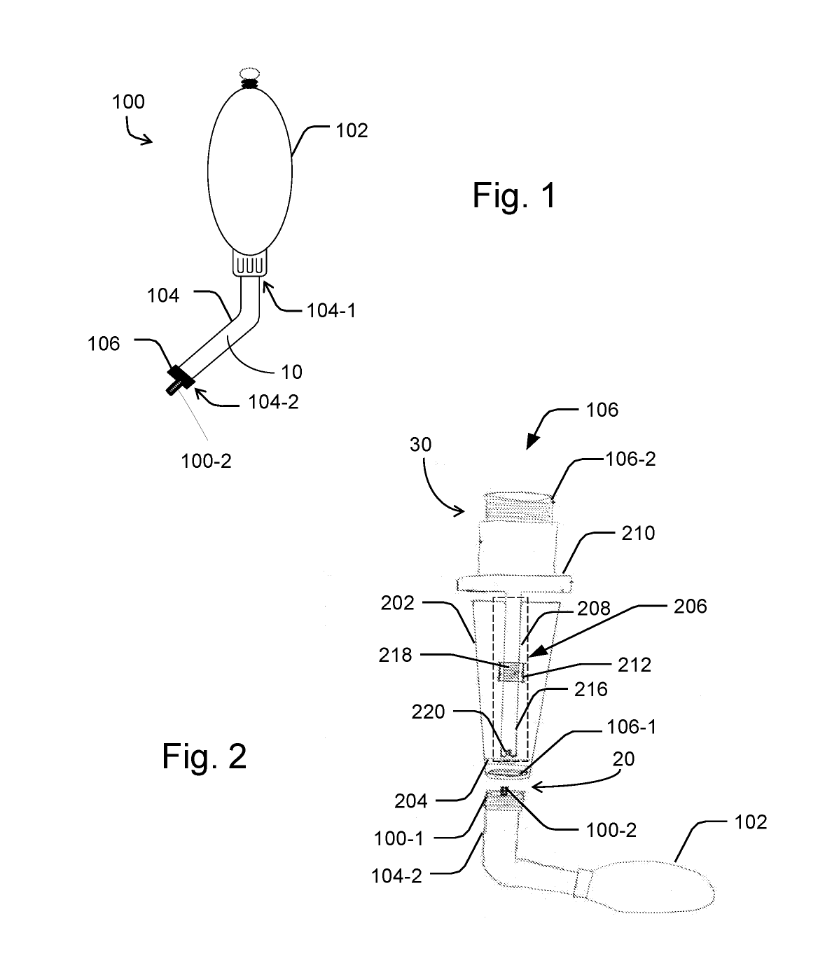

FIG. 1 illustrates an embodiment of apparatus 100 for removing clogs in a drain pipe. The apparatus 100 is used to create a temporary seal inside the drain pipe to isolate a section of the drain pipe that has a clog, from the rest of the drain pipe which is free from the clog. The apparatus 100 includes a tubular conduit 104, also referred to as a valve stem, having a first end 104-1, a second end 104-2 and an inner bore 10. In one example, the conduit 104 can be made of, but not limited to, fiberglass, metals, alloys, and plastic or the like. In the illustrated embodiment, the conduit 104 has a bent shape to allow easy access into the drain pipe through a vent. The conduit 104 includes a valve core 100-2 that can be displaced axially inside the conduit 104 to open and close the inner bore 10 of the conduit 104. In one example, the valve core 100-2 can be a Schrader valve. The end of the valve core is shaped to releasably engage the end of a depressor pin 220 of a dual valve connector 106, described later in connection with FIG. 2.

As also illustrated in FIG. 1, the apparatus 100 includes a bladder 102 installed at the first end 104-1 of the conduit 104. The bladder 102 can be inflated to create the temporary seal inside a drain pipe. In one example, the bladder 102 can be made from, but not limited to, an elastic material capable of withstanding high pressure without failure.

The apparatus 100 also includes a dual valve connector 106 at the second end 104-2 of the conduit 104. The dual valve connector 106 performs two functions. Namely, the dual valve connector 106 allows connection of the apparatus to a source of pressurized air (not shown), such as an air pump, for inflating the bladder. As well, the dual valve connector 106 retains the air inside the bladder when the apparatus is disengaged from the pressurized air source. In this way, the bladder 102 enables pressure sealing of a clogged section of a drain pipe when inflated, and the seal is maintained during removal of the clog.

FIG. 2 illustrates an embodiment of the dual valve connector 106 of the apparatus 100 of FIG. 1. The dual valve connector 106 prevents escape of air from the bladder 102 and allows an engagement of the source of pressurized air to the apparatus 100 (shown in FIG. 1). The dual valve connector 106 includes a body 202 with a first coupler 20, also referred to as the bladder coupler, for connection with the second end 104-2 of the conduit 104, and a second coupler 30 for connection with the air source. For example, bladder coupler 20 may include threads 106-1, provided on the connector 106, to engage with mating threads 100-1 provided on the conduit 100. As well known, in order to connect the dual valve connector 106 to the apparatus 100, the connector 106 is rotated, for example clockwise, to engage threads 100-1 with threads 106-1.

The air source coupler 30, also referred to as the second coupler, may also include threads 106-2 as shown in the example of FIG. 2, which are adapted to engage matting threads (not shown) on an outlet connector of the air source. Other means for releasable connecting the apparatus 100 with the air source and the conduit 104 can be envisaged.

The dual valve connector 106 also includes a seal 204 to provide an air tight seal between the threads 106-1 on the apparatus and the threads 100-1 of the connector 106.

The body 202 of the dual valve connector 106 includes a valve operator 206, adapted to operate the valve core 100-2 provided at conduit 104 of the apparatus 100 (e.g., the Schrader valve, described in connection with FIG. 1). The valve operator 206 includes a rotating shaft 208 and a depressor pin 216 connected inside the body 202 by, for example, female threads 212 on the rotating haft 208, and mating male threads 218 for example, on the depressor pin 216. The rotating shaft 208 can be rotated using a knob 210 shown at the air source side of the dual valve connector 106. The depressor pin 216 has a pin head 220 shaped to engage with the valve core 100-2 on the apparatus 100. In the embodiment of FIG. 2, the depressor pin 216 translates towards or away from e.g. the conduit end of the dual valve connector 106 when the knob 210 is operated (rotated) clockwise or anticlockwise, respectively. In this embodiment, both the rotating shaft 208 and depressor pin 216 are hollow to allow air to flow through.

During operation, the knob 210 is rotated so that the rotating shaft 208 also rotates inside the body 202, thereby rotating the threads 212 into threads 218. As the threads 212 rotate, the rotational motion is converted to a translational

motion of the depressor pin 216. The depressor pin 216 now pushes the valve core 100-2 inside the conduit 104, to enable passage of air through conduit 104, to inflate the bladder 102.

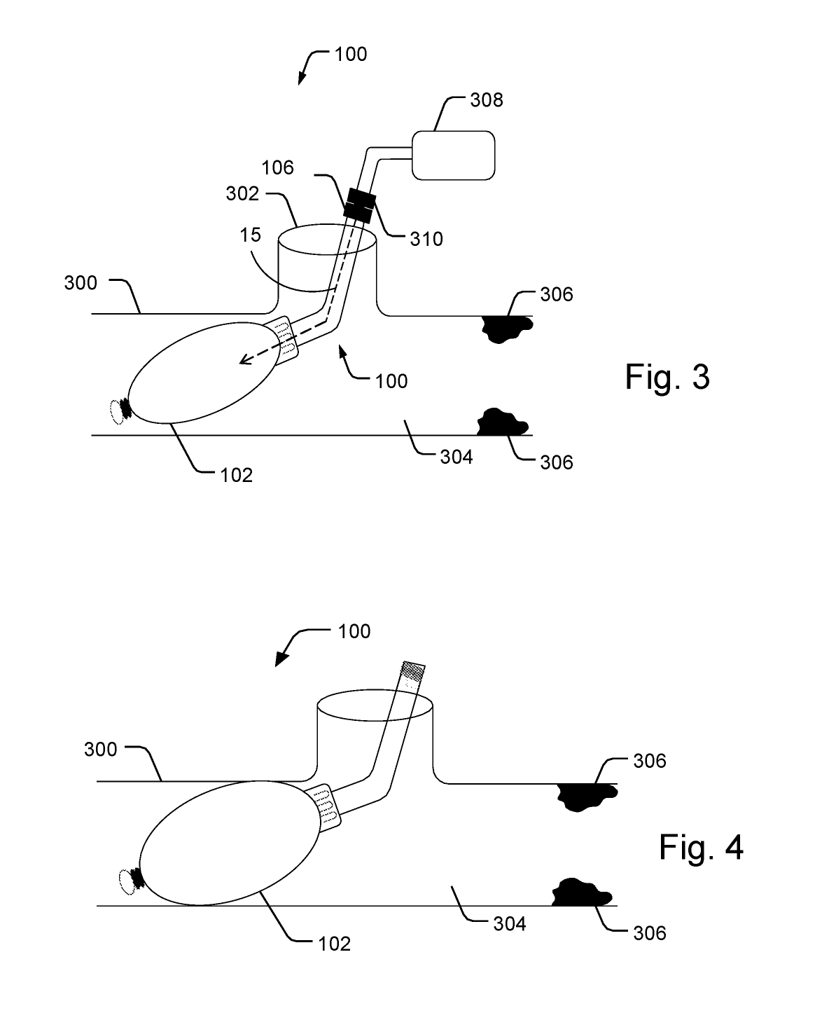

The manner by which the dual valve connector 106 operates will be described in further detail with reference to FIG. 3. FIG. 3 illustrates an example of the apparatus 100 deployed in a section of a drain pipe 300. In the illustrated embodiment, the drain pipe 300 includes a vent 302 through which the interior 304 of the drain pipe 300 can be accessed. In this example, a T-shaped section is formed at the vent 302. FIG. 3 also shows a section 306 of the pipe which is partially clogged.

First, the dual valve connector 106 is secured to the valve stem 104 using first coupler 20. To this end, the user places the female threads 106-1 over the second end of the valve stem 104 and rotates the connector body 202 clockwise so that the threads 106-1 rotate about the threads 100-1 of the valve stem 104. Thereafter, the apparatus 100 is manipulated to be placed at an appropriate location inside the drain pipe 300 to isolate the partially clogged section 306 of the drain pipe 300 from rest of the drain pipe 300. As seen, the bent shape of the conduit 104 allows easy entry of the apparatus 100 into the drain pipe 300, since the shape of the conduit 104 complements the T-shaped section of the vent 302

Once placed in the drain pipe 300, the apparatus 100 is connected to an air source 308 through the second coupler 30 of the dual valve connector 106. FIG. 3 illustrates in dotted lines an air passageway 15 provided between the bladder 102 and the source 308 through the dual valve connector 106 through the inner bore 10 of the conduit 104. The source 308 can be, but is not limited to, a hand operated air pump, or the like. In the illustrated embodiment, the source 308 has a pump connector 310, such as a nozzle, that couples with the second coupler 30.

Once the pump connector 310 engages with the dual valve connector 106, the knob 210 is operated to rotate the rotating shaft 208. Initially, the depressor pin 216 is positioned in such a manner that the depressor pin 216 does not engage with the valve core 100-2 when the dual valve connector 106 is secured to the valve stem 104-2. As the rotating shaft 208 rotates, the depressor pin 216 moves towards the valve core 100-2 until the pin head 220 engages with the valve core 100-2. Rotation of shaft 208 is continued until that the depressor pin 216 pushes the valve core 100-2 inside the valve stem 104 thereby opening air access to the bladder 102 through the passageway 15 (see FIG. 3).

Next, the user pumps the pressurized air from the source 308 into the bladder 102 through the valve operator 206 and the conduit 104 (shown in FIG. 1). The user keeps on pumping the air in the bladder 102 until the bladder 102 forms an air tight seal inside the drain pipe 300. Once the drain pipe is sealed, the bladder 102 isolates the clogged section 306 of the drain pipe 300 from other sections of the drain pipe 300 (i.e., to the left of the bladder 102 in FIG. 3).

Thereafter, the user rotates the knob 210 anticlockwise causing the rotating shaft 208 to rotate anticlockwise. As a result, the threads 218 move the depressor pin 216 away from the valve core 100-2 resulting in the depressor pin 216 disengaging from the valve core 100-2 to return to its original position. As the valve core 100-2 returns to its original position, the passageway 15 is blocked, and so is the access to the bladder 102. The air is now trapped inside the bladder 102, the bladder being in the inflated state. Therefore, with the help of the dual valve connector 106, the bladder 102 is maintained in the inflated state.

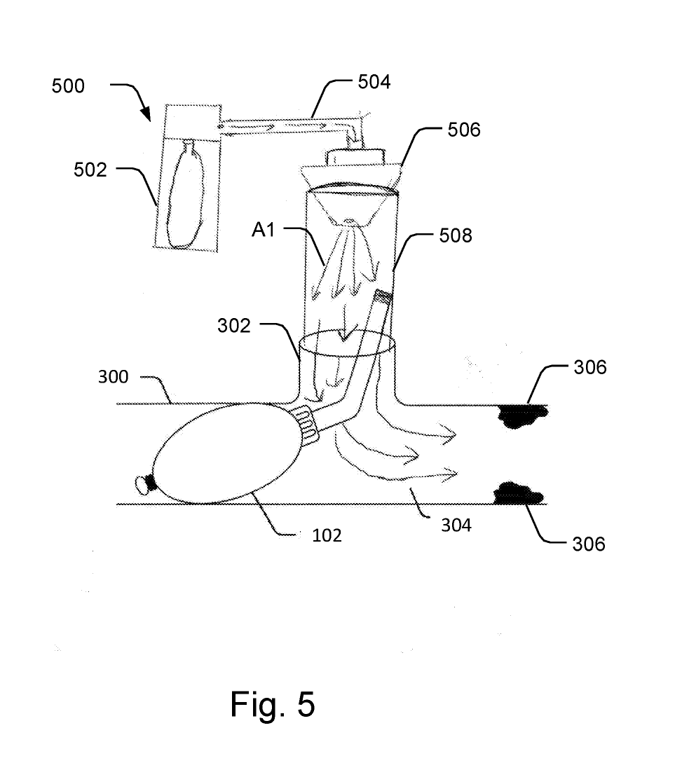

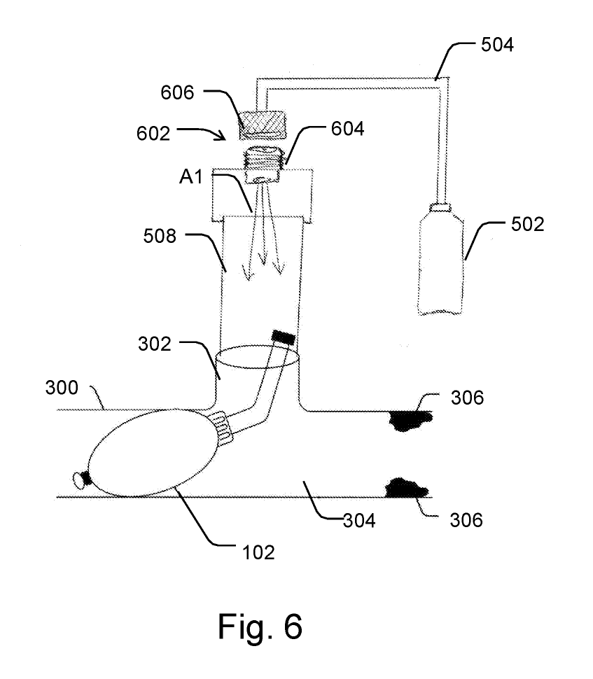

Once the depressor pin 216 has retracted inside body 202, the user rotates the body 202 to disengage with the valve stem 104 from the air source 308. Once the dual valve connector 106 disengages, the bladder 102 with the conduit 104 lies in the drain pipe 300 as shown in FIG. 4. As shown, a part of the conduit 104 extends outside from the vent 302 thereby making the engagement of the apparatus 100 with a clog removal system difficult. This problem is addressed by using an extension for the vent as illustrated in FIGS. 5 and 6 and described next.

FIGS. 5 and 6 illustrate an embodiment of a clog removal system 500 for removing the clogs from a clogged section 306 of a drain pipe. The clog removal system 500 includes a storage tank 502 that stores highly pressurized nitrogen gas or carbon dioxide gas. Clog removal system 500 also includes a hose 504 that connects the storage tank 502 to a clog removal coupler 506. As mentioned previously, the conduit 104 of apparatus 100 protrudes from the vent 302. In order to facilitate pumping of the Nitrogen charge or CO2 Charge into the drain pipe 302, an overlapping pipe 508 is installed on the vent 302. In one example, the overlapping pipe 508 and the vent 302 are fitted to each other to forms an air tight seal therebetween. The overlapping pipe 508 is installed after the bladder 102 is inflated and the dual valve connector 106 is disengaged from the apparatus 100.

As shown in FIG. 5, the overlapping pipe 508 has an open end opposite the end inserted into the vent 302. The coupler 506 has a frusto-conical shape and is inserted into the overlapping pipe 508 as shown. In another embodiment, as shown in FIG. 6, the overlapping pipe 508 has a pipe connector 602 having male threads 604 to engage with female threads of another clog removal coupler 606.

In the clog removal system 500 shown in FIG. 5, once the overlapping pipe 508 was installed on the vent 302, the clog removal coupler 506 is installed on the overlapping pipe 508. The clog removal coupler 506 is pressed to the end of the overlapping pipe 508 to obtain an air tight seal between the overlapping pipe 508 and the clog removal coupler 506. Once coupled, gas from storage tank 502 is introduced in the interior 304 of the drain pipe 300 to remove the clogs sticking along the interior wall of the section 306 of the drain pipe 300. As indicated above, in one example, a nitrogen charge or carbon dioxide charge is pumped into the drain pipe 300 as shown by arrows A1 in FIG. 5. The charge enters the drain pipe 300 and tends to dissipate in all the sections of the drain pipe 300. However, as the bladder 102 blocks the drain pipe section that is free of clogs, the pressure is diverted towards the clogged section 306. In this way, heavy forces are applied to the clogs in the section 306, to dislodge the clogs from the interior wall of the drain pipe. Thereafter, the uprooted clogs are moved under pressure out from the section 306 of the drain pipe 300. This procedure is repeated until all the clogs in the drain pipe 300 are removed. During the cleaning process, the bladder 102 maintains the temporary seal and remains inflated.

Once the clogs 306 are removed, the clog removal coupler 506 or 606 is disengaged from the overlapping pipe 508. Thereafter, the overlapping pipe 508 is removed from the vent 302 so that the apparatus 100 can be accessed. Once the apparatus 100 is accessible, the valve core 100-2 is operated to allow the air to escape. For example, the valve core 100-2 can be depressed with a screwdriver to open air passageway 15. As the valve core 100-2 opens, the air trapped in the bladder 102 escapes from the bladder 102 thereby deflating the bladder 102. With the bladder 102 in the deflated state, the user pulls the apparatus 100 out from the drain pipe 300 through the vent 302. Thus, the clogs 306 are removed from the drain pipe while preventing the nitrogen charge from moving through the unclogged section, which can otherwise prevent the development of pressure inside the drain pipe sufficient to remove the clogs.

Reference throughout this specification to “one embodiment”, “an embodiment”, or “a specific embodiment” or similar terminology means that a particular feature, structure, or characteristic described in connection with the embodiment is included in at least one embodiment and may not necessarily be present in all embodiments. Thus, respective appearances of the phrases “in one embodiment”, “in an embodiment”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

I claim:

1. An apparatus for facilitating clearance of clogs in a drain pipe, the apparatus comprising:
a conduit having a first end and a second end;
an inflatable bladder attached to the first end, and adapted to assume either an inflated state that can seal a drain pipe, or a deflated state; and
a dual valve connector attached to the second end, adapted to removably attach the conduit to a source of pressurized gas, and to maintain the bladder in the inflated state by trapping pressurized gas in the bladder.

2. The apparatus of claim 1 wherein the bladder is made of an elastic material.

3. The apparatus of claim 1, wherein the conduit comprises:
a tubular body with an inner bore;
a threaded portion at the second end for attachment to the dual valve connector; and
a valve core installed in the inner bore.

4. The apparatus of claim 3, wherein the tubular body is made of one of fiberglass, metals, alloys, and plastic.

5. The apparatus of claim 1, wherein the dual valve connector comprises a valve operator which actuates the valve core to either allow the bladder to inflate with the gas so the bladder adopts the inflated state, keeps gas in the bladder so the bladder maintains the inflated state, or allows the bladder to deflate so the bladder adopts the deflated state.

6. The apparatus of claim 3, wherein the valve operator comprises:
a rotating shaft with a knob arranged outside the connector body for enabling rotation of the rotating shaft; and
a depressor pin coupled to the rotting shaft, adapted to convert the rotation of the rotating shaft into a translation movement.

7. The apparatus of claim 6, wherein the depressor pin has a head adapted to engage the valve core, for translating the valve core within the tubular body to open and respectively close the inner bore.

8. A method of clearing clogs in a drain pipe provided with a vent, the method comprising:
providing a gas passageway through a sealant apparatus which includes an inflatable bladder, a dual valve connector and a conduit provided between the bladder and the dual valve connector;
installing the sealant apparatus, in a deflated state, in the drain pipe through the vent;
actuating the sealant apparatus to assume an inflated state, to isolate a clogged section of the drain pipe from an unclogged section of the drain pipe;
connecting a storage tank with highly pressurized gas to the vent and pressure sealing the connection; and
pumping the pressurized gas towards the drain pipe while the sealant apparatus is in the inflated state.

9. The method of claim 8, further comprising:
disconnecting the storage tank from the vent after the clogged section has been cleaned;
actuating the sealant apparatus into a deflated state; and
removing the sealant apparatus from the drain pipe in the deflated state through the vent.

10. The method of claim 8, wherein actuating the sealant apparatus in an inflated state comprises:
connecting the dual valve connector to a source of pressurized gas;
opening the passageway in the dual valve connector and inflating the bladder using the source;
closing the passageway in the dual valve connector while maintaining the bladder in the inflated state; and
disconnecting the apparatus from the source while maintaining the bladder in the inflated state.

11. The method of claim 9, wherein actuating the sealant apparatus into a deflated state comprises:
opening the gas passageway using the dual valve connector to enable the bladder to assume a deflated state; and,
deflating the bladder through the open gas passageway.

12. An apparatus for clearing clogs in a drain pipe, the apparatus comprising:
a conduit with tubular body, a first end, and a second end;
a bladder coupled to the first end, the bladder adapted to assume either an inflated state or a deflated state;
a valve element coupled to the second end, the valve element adapted to releasably connect the conduit to a source of pressurized gas,
wherein a passageway is provided between the bladder and the valve element, the passageway adapted to be open to inflate the bladder with pressurized gas when the first valve element is connected to the source, and to be closed to keep pressurized gas in the bladder when the valve element is disconnected from the source.

13. The apparatus as claimed in claim 12, wherein the conduit is made of one of fiberglass, metals, alloys, and plastic.

14. The apparatus of claim 12, wherein the bladder is made of an elastic material.

15. The method of claim 12, wherein the bladder is made of rubber.

16. The apparatus of claim 12, wherein the valve element is a Schrader valve.

17. The apparatus of claim 12, wherein the shape of the conduit is bent at an angle selected to enable easy installation of the apparatus into the drain pipe through the vent.
